(19) United States
(12) Patent Application Publication
(10) Pub. No.: US 2008/0005968 A1
(43) Pub. Date: Jan. 10, 2008

(54) SHUTTER ASSEMBLY

(75) Inventors: Michael C. Clark, Columbiaville, MI (US); Nathan Greenway, Metamora, MI (US); Brad Kutler, Leonard, MI (US); J. Richard Logan, Oxford, MI (US); Clyde G. Allen, Lapeer, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: TAPCO INTERNATIONAL, Wixom, MI (US)

(21) Appl. No.: 11/428,739

(22) Filed: Jul. 5, 2006

(51) Int. Cl. E05B 65/04

(52) U.S. Cl. 49/63

(57) ABSTRACT

A shutter assembly (24) mounts to a structure (20) and provides storm and security protection to an opening (22). The assembly comprises an upper track (28) and a lower track (30) each extending between first and second proximal and distal ends (34, 38), respectively. A pair of decorative shutters (26) are spaced from one another and disposed adjacent to the tracks (28, 30). A plurality of panel assemblies (46) are in sliding engagement with the upper and lower tracks (28, 30) for covering the opening (22) and each comprises upper and lower rails (52, 54) and a pair of stiles (56) extending therebetween and a panel (58). The panel (58) defines a retention portion (66) disposed along side edges (64) extending outwardly from a plane (68) of the panel (58). Each of the stiles (56) define a stile channel (72) having a configuration corresponding to the retention portion (66) to create an interference fit between the stile channel (72) and the panel (58) for allowing movement when the panel (58) flexes.

### BACKGROUND OF THE INVENTION

1. Field of the Invention

The subject invention relates to a shutter assembly for mounting to a structure and for providing storm and security protection to an opening in the structure, and more specifically to a storm shutter assembly for providing storm protection, especially hurricane protection.

2. Description of the Related Art

Shutters generally are either functional or decorative and decorative shutters are generally for aesthetic purposes only. The decorative shutters are fastened directly to an exterior wall adjacent a window and typically the width of the decorative shutters are not sufficient to traverse the full width of the window. Functional shutters are generally moveable between an open position adjacent the window and a closed position covering the window. When the functional shutters cover the window, the aesthetic appearance of the building suffers because the shutters are no longer adjacent the windows. Further, these functional shutters are typically made of lightweight material that does not provide adequate strength for protection in storms.

Such decorative functional shutters are usually used for decorative purposes only and are generally not storm rated, i.e., the shutter does not provide adequate protection in a storm. In order for the shutters to be functional, expensive hinges, hardware and fastening systems must be purchased to incorporate the functionality. Further, in order to be aesthetically appealing, the shutters must be proportionate to the size of the window opening and each shutter must cover exactly half of the opening. When closed, the shutters must meet perfectly in the middle to cover the opening. Therefore, no shutter can be wider than 20″ to 24″ and still retain an aesthetically desirable appearance.

Storm panels, e.g., wood or plywood panels may be used to cover or protect windows during severe weather. These storm panels are typically non-decorative and do not allow light into the structure. The panels prevent debris from hitting and breaking the windows. Typically, the panels are large and must be manually fastened to the window frame by screws or nails. When there is no severe weather, the panel must be stored elsewhere, e.g., a storage shed or garage and must be located, moved, and secured into place prior to a storm. It is cumbersome and time intensive to mount these storm panels as the storm is approaching. It is also impractical to leave the storms panels mounted year round because the storm panels decrease the aesthetic appearance of the building. Another disadvantage is that these related art storm panels are very hard to install, especially on second story applications.

Installation of the storm panels typically require a top track that must be secured to the wall and a bottom track that must be secured to the wall. However, the storm panels may be directly fastened to the structure without tracks which is also undesirable. Multiple vertical or horizontal panels are then interlocked to span the opening. The panels are heavy, awkward, and cumbersome to handle. Further, the edges of the panels are often sharp and the panels become slippery when wet. Such panels also require heavy-duty fasteners to properly affix to the wall. When installed, these fasteners damage the surface of the wall and leave unsightly holes when removed.

When these storm panels are affixed to the wall with the heavy-duty fasteners, the storm panels become rigidly affixed to the structure. When debris or wind strike the storm panel, the location of the fasteners become stress points and commonly crack, which leads to the storm panels shattering. This is particularly true when the storm panel is formed from a thermoplastic material, such as Plexiglas. However, if the storm panels are not properly affixed to the structure, the entire storm panel may be ripped from the structure.

Other related art assemblies incorporate large metal or reinforced vinyl storm panels that are housed in large boxes either above the window or to the side, commonly referred to as accordion or roll down shutters. These metal storm panels are extended when a storm approaches. However, these large boxes are unsightly blemishes on the buildings. The roll down shutters are operated manually, mechanically with a crank or motor, or electronically with a switch or remote control. These shutters are non-decorative, but are self-storing within the boxes. Because the boxes are visible from the outside, many residential communities have “aesthetic compliance codes” and these shutters are banned.

The related art assemblies are characterized by one or more inadequacies. Accordingly, it would be advantageous to provide a shutter assembly that may both be used to protect openings within the structure and to provide an improved aesthetic appearance. It would also be advantageous to provide an assembly that may remain mounted to the building to provide storm and security protection that is easily opened and closed from within the structure. It would further be advantageous to provide a shutter assembly that is less likely to shatter when subjected to a force from debris or wind.

### SUMMARY OF THE INVENTION AND ADVANTAGES

The subject invention provides a shutter assembly for mounting to a structure and for providing storm and security protection to an opening in the structure. The assembly comprises an upper track extending between first proximal and distal ends and a lower track extending between second proximal and distal ends. A pair of decorative shutters are spaced from one another and disposed adjacent to the upper and lower tracks for providing an aesthetic appearance. A plurality of panel assemblies are in sliding engagement with the upper and lower tracks for covering the opening. Each of the panel assemblies comprises an upper rail, a lower rail, and a pair of stiles extending therebetween, and a panel. The panel defines a top edge, a bottom edge, and side edges extending therebetween and a retention portion is disposed along the side edges extending outwardly from a plane of the panel. Each of the stiles define a stile channel having a configuration corresponding to the retention portion such than an interference fit is created between the stile channel and the panel when the stile channel receives the retention portion to allow movement when the panel flexes.

The subject invention overcomes the inadequacies that characterize the related art invention. Specifically, the subject invention provides shutter and security protection while also improving the aesthetic appearance of the structure. The shutter assembly is relatively lightweight and can be adapted for various openings and for different structures. Another advantage of the subject invention is that the panel assemblies used with the shutter assembly have a less likelihood of cracking and shattering when subjected to a force from debris or wind. The panel assemblies have eliminated the stress points by use of a novel and unique securing configuration of the panels within the panel assemblies.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is an environmental front side view of a structure having openings with shutter assemblies mounted thereto;

FIG. 2 is a perspective view of the shutter assembly;

FIG. 3 is an exploded front perspective view of the shutter assembly;

FIG. 4 is a side view of the shutter assembly;

FIG. 5 is a front view of a panel assembly;

FIG. 6 is cross-sectional view of the panel assembly taken along line 6-6 in FIG. 5;

FIG. 7 is cross-sectional view of the panel assembly taken along line 7-7 in FIG. 5;

FIG. 8 is an enlarged view of the panel assembly indicated by line 8 in FIG. 6;

FIG. 9 is an enlarged view of the panel assembly indicated by line 9 in FIG. 7;

FIG. 10 is an exploded view of one panel assembly;

FIG. 11 is cross-sectional view taken along line 11-11 in FIG. 2;

FIG. 12 is cross-sectional view taken along line 12-12 in FIG. 2; and

FIG. 13 is cross-sectional view taken along line 13-13 in FIG. 2.

### DETAILED DESCRIPTION OF THE INVENTION

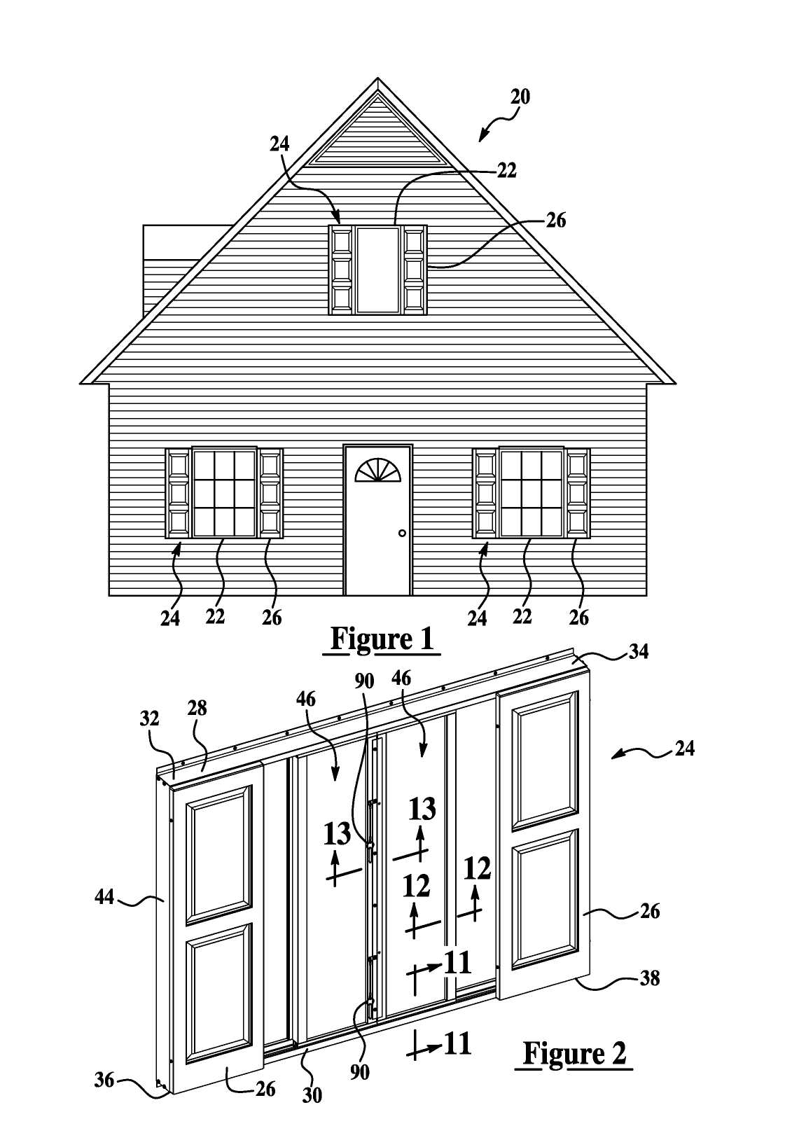

With reference to FIG. 1, an exterior front side view of a structure 20, such as a house, having openings 22 therein, such as doors and windows, is illustrated. More specifically, the structure 20 includes a door with two first story windows positioned on opposite sides and a second story window. Shutter assemblies 24 are illustrated positioned about the openings 22 and each shutter assembly 24 includes two decorative shutters 26. The decorative shutters 26 may be formed to have an appearance of any type of shutter 26, such as louvered shutters or panel shutters. Further, the decorative shutter 26 may be any type of decorative exterior window treatment that enhances the appearance of the structure 20, such as lattice, trellis, or woven panels. The shutter assemblies 24 may be rigidly secured to the structure 20 by appropriate securing devices at a location that aesthetically accents the openings 22.

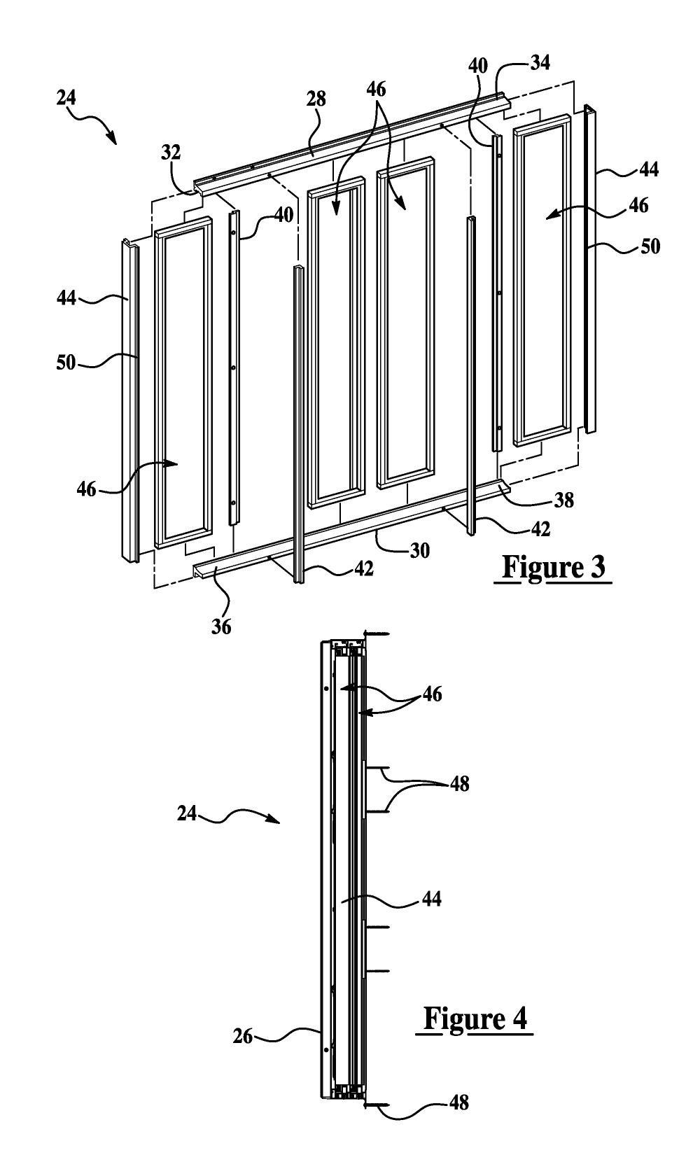

Referring to FIGS. 2 and 3, the shutter assembly 24 generally comprises an upper track 28 and a lower track 30. The upper track 28 extends between a first proximal end 32 and a first distal end 34. The lower track 30 extends between a second proximal end 36 and a second distal end 38. The decorative shutters 26 are spaced from one another and adjacent to the upper and lower tracks 28, 30 for providing an aesthetic appearance. It is to be appreciated that the shutters 26 may be mounted to the track or mounted to additional housings or directly to the structure 20. The upper and lower are preferably formed from a lightweight material, such as, but not limited to, plastic or aluminum. The upper and lower tracks 28, 30 may be concealed by a decorative header and a decorative sill (not shown) for improving an aesthetic appearance of the structure 20.

The shutter assembly 24 also includes a pair of wall interlocks 40, a pair of shutter mounts 42, and a pair of end caps 44 that define a cavity for receiving the panel assemblies 46 when in an open position, which are shown in FIG. 3. The wall interlocks 40 extend between the upper and the lower tracks 28, 30. The wall interlocks 40 may be secured to the structure 20 to provide additional support, as shown in FIG. 4 as fasteners 48. The shutter mounts 42 and the end caps 44 also preferably extend between the upper and the lower tracks 28, 30. It is to be appreciated that the wall interlocks 40, the shutter mounts 42, the end caps 44, and the upper and lower tracks 28, 30 may be formed as an integral housing or formed separately. The end caps 44 preferably enclose the upper and the lower tracks 28, 30. The wall interlocks 40, the shutter mounts 42, the end caps 44, and the upper and lower tracks 28, 30 may be formed of various materials, such as plastic or metal, but are preferably formed from extruded aluminum.

The end caps 44 also include a mounting portion 50, which in combination with the shutter mount 42, receive the decorative shutter 26. Preferably, the decorative shutter 26 has a snap-fit connection with the mounting flange and the shutter mount 42 for securing the decorative shutters 26 thereto. Other well known fasteners may be used to secure the decorative shutters 26, such as screws, rivets, suitable adhesives, or the like. The decorative shutters 26 may also be secured to the upper and lower tracks 28, 30 as is necessary to provide additional support.

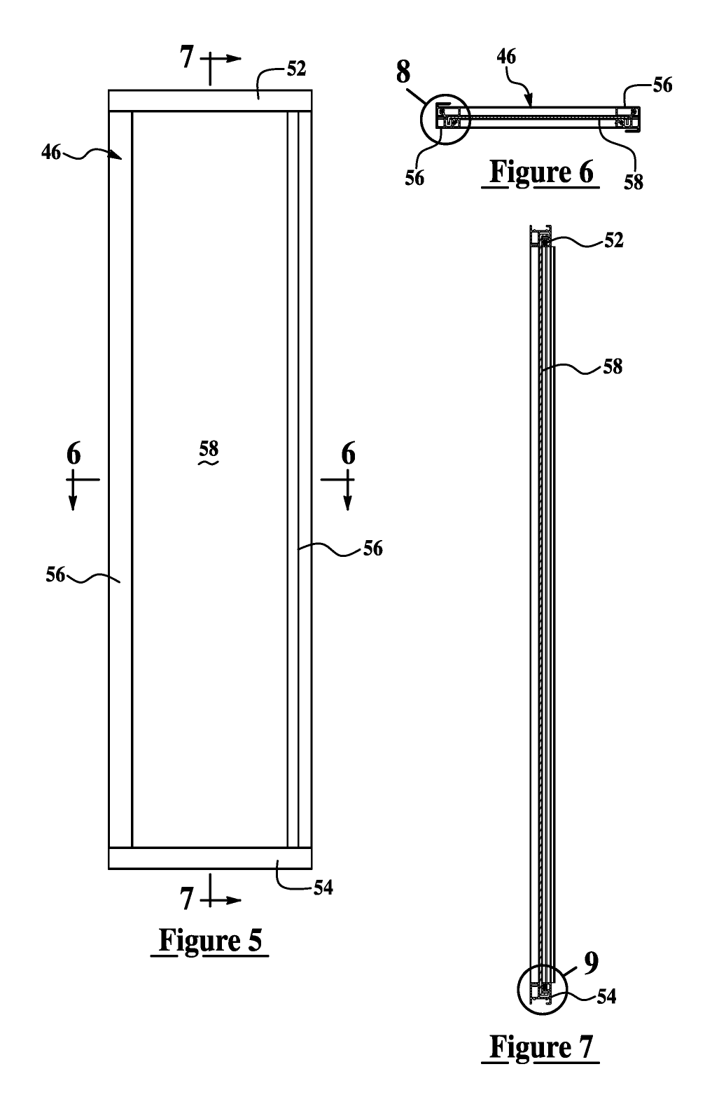

The shutter assembly 24 also includes a plurality of panel assemblies 46 in sliding engagement with the upper and lower tracks 28, 30 for covering the opening 22. A front view of one panel assembly 46 is illustrated in FIG. 5, a top view of the panel assembly 46 is shown in FIG. 6, and a side view is shown in FIG. 7. Referring back to FIG. 3, four panel assemblies 46 are shown covering the opening 22. In this embodiment, two panel assemblies 46 extend from one side of the shutter assembly 24 and two panel assemblies 46 extend from the other side of the shutter assembly 24.

With reference to FIG. 10, an exploded view of the panel assembly 46 is illustrated. Each of the panel assemblies 46 comprises an upper rail 52, a lower rail 54, and a pair of stiles 56 extending therebetween. A panel 58 defining a top edge 60, a bottom edge 62, and side edges 64 extends between the upper and lower rails 52, 54 and the stiles 56. The panel 58 is selected having a width sufficient such that the opening 22 is covered. If more panels 58 are utilized, then each panel 58 may have a smaller width. Further, the panels 58 may be selected to cover larger openings, such as more than two panels 58 are required to enclose the opening 22. It is to be appreciated that the panel 58 may be made of various materials, such as, but not limited to, thermoplastic material, shatterproof glass, film-based materials, reinforced vinyl, plywood, or the like. The panel 58 may also be translucent or opaque depending upon the type of material selected. Preferably, the panel 58 is formed from a polycarbonate material that is translucent to allow light to pass therethrough. The panel 58 may be solid, hollow, or hollow with a reinforcing material disposed therein depending upon the desired amount of protection.

A retention portion 66 is disposed along the side edges 64 of the panel 58, which is shown in FIG. 10. The retention portion 66 extends outwardly from a plane 68 of the panel 58. The retention portion 66 may have various shapes so long as the retention portion 66 secures the panel 58 as will be described in more detail below. The retention portion 66 preferably includes a locking tab 70 extending therefrom. The retention portion 66 is further defined as extending continuously along each of the side edges 64. Preferably, the retention portion 66 is an L-shape.

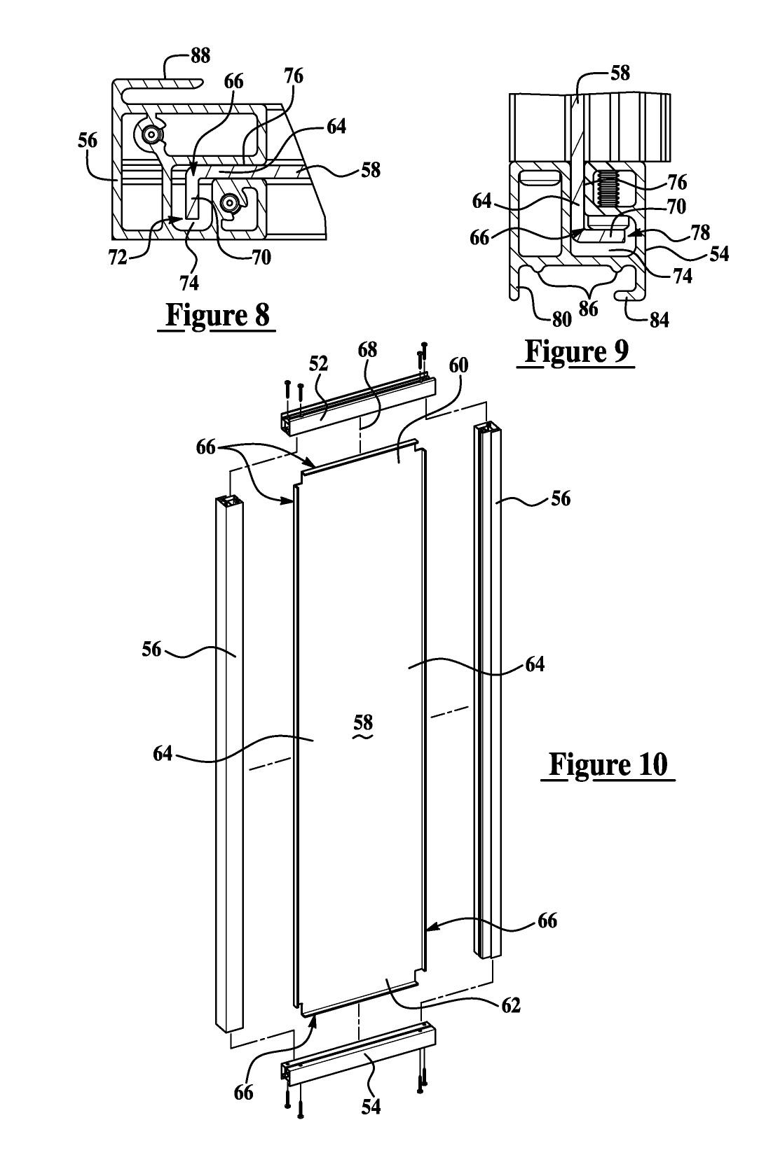

Referring to FIG. 8, a cross-sectional view of the stiles 56 is shown. Each of the stiles 56 define a stile channel 72 having a configuration corresponding to the retention portion 66 such than an interference fit is created between the stile channel 72 and the panel 58 when the stile channel 72 receives the retention portion 66. The stile channel 72 is sized to allow movement when the panel 58 flexes. In other words, when a force is applied to the panel 58, such as from debris striking the panel 58, the panel 58 is able to flex without shattering and without the retention portion 66 becoming dislodged from the stile channel 72.

The stile channel 72 preferably has a retention cavity 74 to allow the movement of the retention portion 66 therein and a neck portion 76 to engage the side edges 64 of the panel 58. The locking tab 70 is received in the retention portion 66 such that the panel 58 is able to slide within the neck portion 76. Preferably, the stile channel 72 is generally an L-shaped configuration. The stile channel 72 may extend continuously along the stiles 56 or may be spaced, discrete sections along the stiles 56.

With reference back to FIG. 10, the panel 58 formed according to the subject invention may also have the retention portion 66 extending outwardly from the top edge 60 and bottom edge 62 of the panel 58. The retention portion 66 may further extend continuously along each of the top and bottom edges 60, 62. Said another way, the panel 58 includes the retention portion 66 along the side edges 64 and the top and bottom edges 60, 62 to ensure the panel 58 remains secured to the stiles 56 and upper and lower rails 52, 54 when subjected to a force.

Referring to FIG. 9, a cross-sectional view of the lower rails 54 is shown. It is to be appreciated that the upper rail 52 may have a similar configuration to the lower rail 54. Each of the upper and lower rails 52, 54 further defines a rail channel 78 having a configuration corresponding to the retention portion 66. The rail channel 78 may extend continuously along each of the rails 52, 54. The rail channel 78 preferably includes the retention cavity 74 to allow movement of the retention portion 66 therein and the neck portion 76 to engage the top and bottom edges 60, 62 of the panel 58. More preferably, the rail channel 78 has an L-shaped configuration.

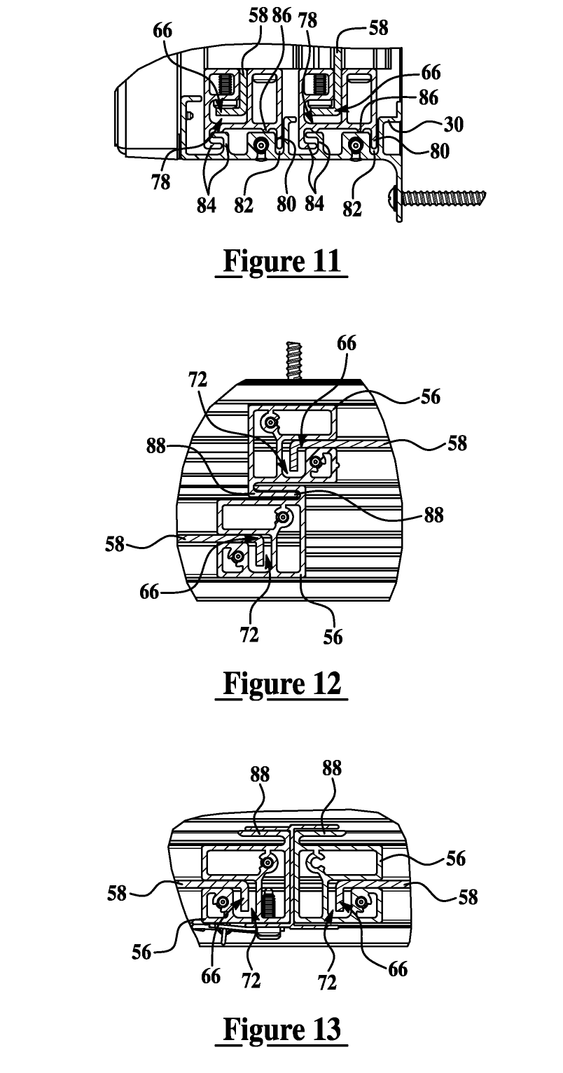

Referring to again to FIGS. 9 and 11, the lower rail 54 is illustrated as having a configuration for engaging the lower track 30. The lower rail 54 has a rear member 80 that is slideably received in a rear slot 82 of the lower track 30. Both the lower rail 54 and the lower track 30 include interlocking portions 84 for engaging one another as the lower rail 54 slides along the lower track 30. Glider buttons 86 may also be disposed on either or both of the upper and the lower rails 52, 54 to provide support while sliding.

The upper and lower rails 52, 54 and the stiles 56 may be formed from plastic or metal materials, but are preferably formed from aluminum. Further, it is preferred that the upper and lower rails 52, 54 and the stiles 56 are formed in an extrusion process and more preferably from extruded aluminum.

Referring back to FIG. 8, each of the stiles 56 further comprise an interlocking member 88 extending therefrom for engaging adjacent panel assemblies 46. It is to be appreciated that one panel assembly 46 may include only one interlocking member 88 or that the panel assembly 46 may include more than one interlocking member 88. In other words, the panel assembly 46 may include two interlocking members 88 if both stiles 56 include the interlocking member 88. Further, the interlocking members 88 may extend from opposite sides of the panel assembly 46. Referring to FIGS. 12 and 13, one interlocking member 88 of the panel assembly 46 engages the interlocking member 88 of the adjacent panel assembly 46 such that the two panel assemblies 46 are telescopically interlocked with one another. Said another way, extending one of the panel assemblies 46 results in both panel assemblies 46 extending therefrom, which is shown best in FIG. 12. Referring to FIG. 13, the opposite stile 56 of the panel assembly 46 abuts the stile 56 of the opposite panel assembly 46 and covers the opening 22. The other half of the shutter assembly 24 would also be slid close in a similar fashion. The other interlocking member 88 may engage the wall interlock 40 to limit motion of the panel assemblies 46.

Referring back to FIG. 2, the shutter assembly 24 may also include a locking mechanism 90 for locking the panel assemblies 46 in an extended position. The locking mechanism 90 may connect adjacent stiles 56 of the opposite panel assemblies 46 to provide additional support for covering the opening 22.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A shutter assembly for mounting to a structure and for providing storm and security protection to an opening in the structure, said assembly comprising:
an upper track extending between first proximal and distal ends;
a lower track extending between second proximal and distal ends;
a pair of decorative shutters spaced from one another and adjacent to said upper and lower track for providing an aesthetic appearance;
a plurality of panel assemblies in sliding engagement with said upper and lower tracks for covering the opening;
each of said panel assemblies comprising an upper rail, a lower rail, and a pair of stiles extending therebetween;
a panel defining a top edge, a bottom edge, and side edges extending therebetween;
a retention portion disposed along said side edges extending outwardly from a plane of said panel; and
each of said stiles defining a stile channel having a configuration corresponding to said retention portion such than an interference fit is created between said stile channel and said panel when said stile channel receives said retention portion to allow movement when said panel flexes.

2. A shutter assembly as set forth in claim 1 wherein said stile channel is further defined as having a retention cavity to allow movement of said retention portion therein.

3. A shutter assembly as set forth in claim 2 wherein said stile channel is further defined as having a neck portion to engage said side edges of said panel.

4. A shutter assembly as set forth in claim 3 wherein said stile channel is further defined as generally having an L-shaped configuration.

5. A shutter assembly as set forth in claim 3 wherein said retention portion is further defined as a locking tab received in said retention portion such that said panel is able to slide within said neck portion.

6. A shutter assembly as set forth in claim 1 wherein said stile channel is further defined as extending continuously along said stiles.

7. A shutter assembly as set forth in claim 6 wherein said retention portion is further defined as extending continuously along each of said side edges.

8. A shutter assembly as set forth in claim 3 wherein said retention portion is further defined as extending outwardly from said upper and lower edges of said panel.

9. A shutter assembly as set forth in claim 8 wherein each of said upper and lower rails further define a rail channel having a configuration corresponding to said retention portion.

10. A shutter assembly as set forth in claim 9 wherein said rail channel is further defined as having said retention cavity to allow movement of said retention portion therein.

11. A shutter assembly as set forth in claim 10 wherein said rail channel is further defined as having said neck portion to engage said upper and lower edges of said panel.

12. A shutter assembly as set forth in claim 11 wherein said rail channel is further defined as generally having an L-shaped configuration.

13. A shutter assembly as set forth in claim 9 wherein said rail channel is further defined as extending continuously along each of said rails.

14. A shutter assembly as set forth in claim 13 wherein said retention portion is further defined as extending continuously along each of said top and bottom edges.

15. A shutter assembly as set forth in claim 1 wherein each of said stiles further comprise an interlocking member extending therefrom for engaging adjacent panel assemblies.

16. A shutter assembly as set forth in claim 1 further comprising a locking mechanism for locking said panel assemblies in an extended position to cover the opening.

17. A panel assembly for use with a shutter assembly having upper and lower tracks mounted to a structure adjacent an opening, said panel assembly comprising:
an upper rail and a lower rail in sliding engagement with the upper and lower tracks and a pair of stiles extending therebetween;
a panel defining a top edge, a bottom edge, and side edges extending therebetween;
a retention portion disposed along said side edges extending outwardly from a plane of said panel; and
each of said stiles defining a stile channel having a configuration corresponding to said retention portion such than an interference fit is created between said stile channel and said panel when said stile channel receives said retention portion to allow movement when said panel flexes.

18. A panel assembly as set forth in claim 17 wherein said stile channel is further defined as having a retention cavity to allow movement of said retention portion therein.

19. A panel assembly as set forth in claim 18 wherein said stile channel is further defined as having a neck portion to engage said side edges of said panel.

20. A panel assembly as set forth in claim 19 wherein said stile channel is further defined as generally having an L-shaped configuration.

21. A panel assembly as set forth in claim 19 wherein said retention portion is further defined as a locking tab received in said retention portion such that said panel is able to slide within said neck portion.

22. A panel assembly as set forth in claim 17 wherein said stile channel is further defined as extending continuously along said stiles.

23. A panel assembly as set forth in claim 22 wherein said retention portion is further defined as extending continuously along each of said side edges.

24. A panel assembly as set forth in claim 19 wherein said retention portion is further defined as extending outwardly from said upper and lower edges of said panel.

25. A panel assembly as set forth in claim 24 wherein each of said upper and lower rails further define a rail channel having a configuration corresponding to said retention portion.

26. A panel assembly as set forth in claim 25 wherein said rail channel is further defined as having said retention cavity to allow movement of said retention portion therein.

27. A panel assembly as set forth in claim 26 wherein said rail channel is further defined as having said neck portion to engage said upper and lower edges of said panel.

28. A panel assembly as set forth in claim 27 wherein said rail channel is further defined as generally having an L-shaped configuration.

29. A panel assembly as set forth in claim 17 wherein each of said stiles further comprise an interlocking member extending therefrom for engaging adjacent panel assemblies.
